(19) United States
(12) Patent Application Publication
(10) Pub. No.: US 2004/0044130 A1
(43) Pub. Date: Mar. 4, 2004

(54) Heat thickening composition for coating slips based on a copolymer having a lower critical solubility temperature

(76) Inventors: Marie-Pierre Labeau, Levallois-Perret (FR); Jean-Christophe Castaing, Paris (FR); Francis Dobler, (US); Cecile Bonnet-Gonnet, Paris (FR); Dominique Charmot, Los Gatos, CA (US)

Correspondence Address: BURNS DOANE SWECKER & MATHIS L L P, POST OFFICE BOX 1404, ALEXANDRIA, VA, 22313-1404, US

(21) Appl. No.: 10/642,328

(22) Filed: Aug. 18, 2003

Related U.S. Application Data
(62) Division of application No. 09/720,377, filed on Apr. 12, 2001.
Application No. 09/720,377 is a 371 of international application No. PCT/FR99/01525, filed on Jun. 24, 1999.

(30) Foreign Application Priority Data
Jun. 26, 1998 (FR) 98/08,171

(51) Int. Cl. C08G 63/48

(52) U.S. Cl. 525/64

(57) ABSTRACT

The invention concerns a heat thickening composition for coating baths comprising at least a heat-sensitive copolymer, characterised in that said copolymer has a comb structure and consists of a polymeric segment called skeleton segment whereto are grafted at least two polymeric lateral segments, identical or different, with either the skeleton segments and/or the lateral segments having a low critical solubility temperature (LCST) ranging between 30 and 80° C. The invention also concerns a coating bath comprising said composition and their uses for coating paper or cardboard.

The present invention relates to a novel heat thickening composition for coating slips which can substitute for or be used in combination with conventional thickening additives employed in these slips.

The present invention relates more particularly to a novel thickening composition which improves the coverage of the surface coat of cellulose substrates and reduces the mottling on printing.

In conventional coating operations, the heterogeneity in look-through, inherent to any cellulose substrate or board, and its porous and absorbent nature, result in defects in the coverage of the substrate by the surface coat.

In fact, these defects relate essentially to two separate phenomena.

Although the coating operation is targeted at depositing this slip specifically at the surface and in avoiding its penetration into the substrate, a not insignificant absorption of the coating bath by the substrate is also observed. This results in a loss in the efficiency of the coating since, in order to achieve the same level of suitability, a greater weight of coat must be deposited to compensate for the coat absorbed by the substrate. The losses in qualities brought about are losses in opaqueness, in smoothness and/or in gloss. This absorption of the slip into the substrate is a defect which becomes more damaging in proportion as the weights of coats decrease and it thus becomes critical under the threshold of a weight of coat of approximately 6 g/m².

The second type of defect corresponds to heterogeneities in the structure and the composition of the coat coated onto the substrate. Its commonest and most damaging manifestation is mottling of the print. Mottling is a phenomenon which is revealed by fluctuations in the print renderings when the coat is printed. Defects of this type are brought about in particular by phenomena of migration of the slip into the substrate. For a slip not corresponding to the present invention, these phenomena of migration and the defects which they generate are in particular brought about and enhanced by the drying of the coat. Thus, the heating applied to the coat in order to dehydrate it has the effect of decreasing its viscosity and so enhancing in proportion the phenomena of migration.

Coating slip compositions conventionally comprise, in addition to fillers, at least one thickening agent which has the main function of precisely controlling the viscosity and the water retention of the coating slip. They are generally cellulose derivatives, such as carboxymethylcellulose, or alkali thickening highly carboxylated synthetic polymers. Unfortunately, these compounds have the disadvantage of exhibiting a viscosity which significantly decreases at a temperature above 45° C. They thus promote phenomena of migration during the dehydration operation and do not make it possible to prevent the appearance of the defects mentioned above.

The present invention is thus targeted at providing a novel thickening composition for coating slips which is of use in particular in that it makes it possible to prevent phenomena of migration on drying and the defects which result therefrom.

More specifically, it provides a novel thickener which has the advantage of resulting in an increase in the viscosity of the applied coat when it is dried, which increase thus blocks phenomena of migration. The result of this is an improvement in the coverage of the surface coat of the cellulose substrate and a significant reduction in the mottling on printing.

A first subject matter of the present invention is consequently a heat thickening composition based on at least one heat-sensitive copolymer which makes it possible to be liberated from the problems mentioned above.

The term “heat-sensitive copolymer” is understood to mean a polymer with a viscosity in an aqueous medium which increases with the temperature beyond a temperature threshold, in contrast to conventional polymers, the viscosity of which continuously decreases with the rise in the temperature.

The present invention takes advantage in particular of the property of certain water-soluble polymer chains of locally combining together beyond a certain temperature threshold. This results in the formation of a physical network with a high molar mass and thus an increase in viscosity, thus creating the heat thickening property.

Copolymers of this type are already known in particular in the oil industry and more particularly in the field of drilling fluids. Advantage is in particular taken there of the property of polyoxyalkylene chains, which are water-soluble at ambient temperature, of becoming hydrophobic at a temperature, referred to as the critical temperature, above 100° C.

Other polymers, cellulose derivatives such as methylcellulose or ethylhydroxyethylcellulose, have the desired heat thickening property but are generally used as ordinary Theological agents. However, the solutions of these polymers become highly turbid beyond their critical temperature, which is characteristic of the formation of concentration heterogeneities. In point of fact, in applications relating to the coating of paper, in order to succeed in improving the homogeneity of the quality of the coat, it is necessary for the increase in viscosity to take place in a completely homogeneous medium, which renders such polymers unsuitable for these applications.

Unexpectedly, the inventors have demonstrated that it is possible to reproduce the phenomenon of water-soluble/hydrophobic transition mentioned above at low concentrations and for a range of temperatures well below 100° C. and thus more suited to use in the paper coating industry.

Furthermore, the copolymers used according to the invention have the characteristic of having, in solution, a virtually zero variation in turbidity beyond the critical temperature. This property means that the solutions of polymers according to the invention retain, in the temperature range of their use, a degree of homogeneity which makes it possible to obtain a more even and more uniform structure of coats applied in the manufacture of paper.

Consequently, a first subject matter of the present invention is a heat thickening composition for coating slips comprising at least one heat-sensitive copolymer, characterized in that said copolymer has a comb structure and is composed of a polymer segment, known as the backbone segment, to which are grafted at least two identical or different polymer side segments with either the backbone segment or the side segments having a lower critical solubility temperature LCST of between 30 and 80° C.

Within the meaning of the present invention, the term “segment” covers either a linear linkage or a branched linkage.

According to a first alternative form of the invention, it is the polymer segment referred to as the backbone segment which has a lower critical solubility temperature LCST of between 30 and 80° C.

According to a second alternative form of the invention, which is the preferred one, it is the polymer side segments which have a lower critical solubility temperature LCST of between 30 and 80° C.

Finally, according to another alternative form of the invention, the claimed heat thickening composition comprises several copolymers as defined above. These copolymers are arranged together therein so as to form a crosslinked structure in which their polymer segments having the lower critical solubility temperature LCST are the crosslinking nodes and at least a portion of their segments not having a lower critical solubility temperature between 30 and 80° C. establish connections between said nodes.

According to these alternative forms, the segment not having the required LCST, namely between 30 and 80° C., is for its part water-soluble, at least in this temperature range.

It is also possible to envisage, in the context of the present invention, that the segment not exhibiting the LCST of between 30 and 80° C. should nevertheless have an LCST. However, it is then necessary for this segment to be water-soluble in the temperature range under consideration (30-80° C.). This implies that its LCST is above 80° C.

More specifically, the polymer segments having a lower critical solubility temperature exhibit a water-soluble nature at a temperature below their LCST. As regards the polymer segments not possessing a lower critical solubility temperature in the temperature range concerned, they are water-soluble at least in the operating temperature range of the heat thickening composition, preferably between +10° C. and +100° C.

As regards the polymer segment not having a critical temperature, it is more preferably a water-soluble polymer of ethylenic type.

These water-soluble polymers can result from the (co)polymerization of water-soluble ethylenic monomers. These monomers can in particular be of vinyl, acrylic, styrene or diene type or of vinyl ester type.

Mention may be made, as examples of vinyl monomers, of vinylsulfonic acid, methallylsulfonic acid or their salts.

Mention may be made, as examples of acrylic monomers, of (meth)acrylic acid, diacids, such as fumaric acid or itaconic acid, or their salts, maleic anhydride, or acrylamide and its derivatives, such as acrylamidomethylpropanesulfonic acid, or their salts.

Mention may be made, as examples of styrene monomers, of styrenesulfonic acid, vinylbenzoic acid or their salts.

The water-soluble monomers mentioned above can also be combined with or substituted by hydrophobic monomers, the units of which, once incorporated in the polymer chain, can be converted, in particular by a chemical treatment, such as hydrolysis, into water-soluble units. They are, for example, methyl (meth)acrylate, tert-butyl (meth)acrylate, glycidyl (meth)acrylate and vinyl acetate.

Finally, any organosoluble monomer can also be used and incorporated in the polymer chain in the form of hydrophobic units. Present in small amounts of in the polymer segment, they make it possible to control the solubility in water of the corresponding copolymer.

Of course, the various monomers are selected so that the corresponding polymer segment exhibits a solubility in aqueous medium in accordance with the invention. This adjustment of the relative amounts of corresponding monomers comes within the competence of a person skilled in the art.

Monomers such as acrylic or methacrylic acid, acrylamides and their derivatives, fumaric and maleic acids and sulfonated monomers, such as 2-acrylamidomethylpropanesulfonic acid (AMPS) and its alkaline salts and vinylsulfonate, are in particular preferred according to the invention.

More preferably, this type of polymer segment has a molecular weight at least greater than 1 000 and preferably at least greater than 20 000.

Advantageously, these polymer segments result from the polymerization of acrylic acid (AA) and/or 2-acrylamidomethylpropanesulfonic acid (AMPS).

As regards the polymer segments having a lower critical solubility temperature LCST of between 30 and 80° C., they derive from polyoxyalkylene polymers.

According to a preferred form of the invention, the oxyalkylene unit or various oxyalkylene units present in the polyoxyalkylene polymer have at most 6 carbon atoms.

Preferably, the segments exhibiting a critical temperature (LCST) are composed of oxyethylene (OE) units and/or oxypropylene (OP) units.

The OE and OP units can be arranged in the heat-sensitive polymer segment in the random or block form. The heat-sensitive polymer segment can, for example, exhibit a star structure. It proves to be possible to adjust the critical solubility temperature through in particular the length and the composition of these polymer segments. Preferably, the segments exhibiting a critical temperature in accordance with the invention are composed of at least 5 oxyalkylene units.

More preferably, they are corresponding macromonomers.

Within the meaning of the present invention, a macromonomer denotes a macromolecule carrying one or more ethylenic functional groups which can (co)polymerize by the radical route.

The grafting of the polymer side segments to a polymer segment referred to as the backbone segment can be carried out according to conventional techniques familiar to a person skilled in the art (European Polymer Journal, 4, 343 (1968); U.S. Pat. No. 3,719,647).

Mention may in particular be made, among these conventional techniques, of those referred to as direct grafting and copolymerization.

The direct grafting consists in (co)polymerizing the chosen monomer(s) by the radical route in the presence of the polymer selected to form the backbone of the final product. If the monomer/backbone pair and the operating conditions are carefully chosen, then there may be a transfer reaction between the growing macroradical and the backbone. This reaction generates a radical on the backbone and it is from this radical that the graft grows. The primary radical resulting from the initiator can also contribute to the transfer reactions.

For its part, the copolymerization employs, in a first step, the grafting to the end of the heat-sensitive segment of a functional group which can (co)polymerize by the radical route. This grafting can be carried out by conventional methods of organic chemistry. Then, in a second step, the macromonomer thus obtained is copolymerized with the monomer chosen to form the backbone and a copolymer referred to as an “comb” copolymer is obtained.

It is obvious to a person skilled in the art that, when the copolymerization is carried out of a macromonomer and of a monomer which are chosen so that these two species are strongly combined together by hydrogen bonds, then there is simultaneously direct grafting onto the polymer segment of the macromonomer and incorporation of this macromonomer in the copolymer chain by simple copolymerization of its (co)polymerizable end. In this case, the structure obtained is substantially more branched or even crosslinked than in the two preceding cases.

Preferably, the copolymer comprises 0.1 molar % to 50 molar % and preferably 0.1 molar % to 5.0 molar % of polymer segments having a lower critical solubility temperature (LCST) of between 30 and 80° C.

In solution, the copolymers of the invention advantageously exhibit a slight variation in turbidity as a function of the temperature, which distinguishes them from the other polymers having the heat thickening nature.

Preferably, in aqueous solution, the polymers according to the invention exhibit an imperceptible variation in turbidity such that, at a concentration equal to 2%, the variation in absorbance of the solution, measured with a turbidimeter (662 Photometer from Metrohm), is less than 0.1 in the temperature range between 20 and 60° C.

The heat thickening compositions comprising at least:

one copolymer prepared from POE-POP-POE triblock macromonomer and from acrylic acid (respective molar percentages: 2.3% and 97.7%), preferably by direct grafting,

one copolymer prepared from POE-POP-POE triblock macromonomer and from acrylic acid (respective molar %: 1.6% and 98.4%), preferably by copolymerization,

one copolymer prepared from POE-POP-POE triblock macromonomer and from acrylic acid (respective molar %: 3% and 97%), preferably by copolymerization, and/or

one copolymer prepared from POE-POP-POE triblock macromonomer and from acrylic acid (respective molar %: 2% and 98%), preferably by copolymerization, are very particularly suitable for the invention.

The compositions according to the invention are particularly of use as thickening agent in the paper coating industry and more particularly as an agent for improving the homogeneity and the quality of the coat coverage.

They are preferably introduced into the coating slip at levels of the order of 0.1 to 3 parts by weight, expressed per 100 parts of fillers.

This composition can be mixed with the other components conventionally employed in coating slips.

These components include fillers of pigment type. They are inorganic pigments, such as kaolin, satin white, calcium carbonate, talc, titanium oxide or pigments referred to as plastic pigments. They can also be binders of latex type, in a proportion of 3 to 50 parts by dry weight per 100 parts of pigments.

Of course, this coating slip composition can comprise other additional agents such as release agents, for example stearates, insolubilizing agents, coloring agents, fluorescent whiteners, whitening promoters, such as polyvinyl alcohol, sequestering agents, biocides, antifoaming agents, and the like.

Generally, the coating slip composition comprises 40 to 75% by weight of dry matter and has a pH of between 6 and 10.

The coats are coated at the surface of a cellulose substrate according to conventional coating techniques.

The presence of at least one copolymer as defined above in the coating slip advantageously makes it possible to improve the coat coverage homogeneity. The copolymer contributes to optimizing the immobilization of the coat applied in the manufacture of paper and thus makes it possible to effectively oppose the migrations which generally take place during the drying of the coat applied in the manufacture of paper. This results in a significant improvement in the printing qualities of the coats applied in the manufacture of paper.

Thus, a better homogeneity in the coat structure, superior coat spreading properties, and blocking of the migrations of the constituents of said coat are simultaneously observed. This is reflected by a more homogeneous impression and a faster ink taking.

The simultaneous improvement in the coat homogeneity and the blocking of migration obtained according to the present invention thus renders the claimed heat thickening compositions particularly advantageous with regard to methylcellulose, which does not allow these two points to be improved simultaneously.

Another subject matter of the present invention is a coating slip for the coating of paper and/or board comprising at least one heat thickening composition according to the invention.

It also relates to the use of a heat thickening composition as defined above in a coating slip or of a coating slip in accordance with the invention in obtaining better coat coverage, improving the coat coverage in the coating of paper and board with a low weight of coat and/or improving the smoothness, the opaqueness and/or the gloss of coated paper and board with a low weight of coat.

Within the meaning of the invention, the term “coated paper or board with a low weight of coat” is understood to mean paper or board coated with a coating of less than or equal to 6 g/m².

The present invention is also targeted at the use of a heat thickening composition in accordance with the invention in a coating slip or of a coating slip according to the invention in reducing and/or preventing mottling of the impression.

The examples and figures submitted below are presented by way of illustration and without implied limitation of the present invention.

### FIGURES

FIG. 1: Change in the turbidity of a copolymer according to the invention and of a control (methylcellulose) as a function of the temperature.

FIG. 2:

Change in the viscosity of a coating slip comprising a heat thickening composition according to the invention (copolymer 1) as a function of the temperature and for a constant controlled stress.

FIG. 3:

Change in the viscosity of a coating slip comprising a heat thickening composition according to the invention (copolymer 2a) as a function of the temperature and for a constant controlled stress.

FIG. 4:

Change in the viscosity of a coating slip comprising a heat thickening composition according to the invention (copolymer 2b) as a function of the temperature and for a constant controlled stress.

FIG. 5:

Change in the viscosity of a coating slip comprising a heat thickening composition according to the invention (copolymer 3) as a function of the temperature and for a constant controlled stress.

FIG. 6:

Change in the phenomenon of migration which takes place during the deposition and the drying of a coat applied in the manufacture of paper, in the presence and in the absence of a heat thickening composition according to the invention.

### EXAMPLE 1

### Preparation of a Copolymer with “BRANCHED” STRUCTURE by Direct Grafting of PAA onto a POE-POP-POE Triblock Copolymer

Copolymer 1:

Azobisisobutyronitrile AIBN® (0.030 g, 0.2×10⁻³ mol), acrylic acid (6 g, 8.33×10⁻² mol) and Pluronic PE6400® (number-average molar mass: approximately 3 000; percentage by mass of OE units: 40%; LCST: approximately 69° C.) (6 g, 0.002 mol), sold by BASF, are successively introduced into a tube which is subsequently placed in an oven, the temperature of which is maintained at 70° C. After 12 h, the polymer is gradually dissolved in a basic aqueous solution (sodium hydroxide: 3.4 g; water: 276 g).

### EXAMPLE 2

### Preparation of Macromonomers:

Macromonomer 1:

The synthesis is carried out under nitrogen. Pluronic PE6400® (100 g, 0.033 mol) and maleic anhydride (3.596 g, 0.0366 mol) are introduced into a 100 ml three-necked round-bottomed flask surmounted by a reflux condenser and immersed in a heating oil bath. The temperature is brought from 25° C. to 60° C. over 20 min, maintained at 60° C. for 15 min, then increased to 140° C. and maintained for 12 h. The macromonomer is subsequently used as is.

Macromonomer 2:

The synthesis is carried out under nitrogen. Antarox E-400® (sold by Rhodia) (number-average molar mass: approximately 3 200; percentage by mass of OE units: 39%; LCST: approximately 55° C.) (100 g, 0.031 mol) and maleic anhydride (3.37 g, 0.0343 mol) are introduced into a 100 ml three-necked round-bottomed flask surmounted by a reflux condenser and immersed in a heating oil bath. The temperature is brought from 25° C. to 60° C. over 20 min, maintained at 60° C. for 15 min, then increased to 140° C. and maintained for 12 h. The macromonomer is subsequently used as is.

### EXAMPLE 3

### Synthesis of Copolymers with a Comb Structure:

Copolymer 2 (from the Macromonomer 1: 1.6 molar %):

The synthesis is carried out under nitrogen. The following:

11.8 g of macromonomer 1 (3.8×10⁻³ mol),

480 g of water,

0.0415 g of ammonium peroxodisulfate,

are successively introduced into a 1 l glass reactor surmounted by a reflux condenser and equipped with a magnetic or mechanical stirrer and temperature probe. The temperature is brought from 25° C. to 40° C. over 20 min and then to 45° C. over 10 min. It is subsequently maintained at 45° C. Acrylic acid (17.346 g, 0.241 mol) and ascorbic acid (0.0166 g) are separately introduced continuously over 5 h, while the temperature is maintained at 45° C. for a total of 14 h. The complex formed during the polymerization is subsequently separated from the aqueous phase and redissolved in a basic aqueous solution (pH: approximately 8.4; concentration by mass: approximately 8.0%).

Copolymer 3 (from the macromonomer 2: 3 molar 5):

The synthesis is carried out under nitrogen. The following:

30 g of macromonomer 2 (9.1×10⁻³ mol),

381 g of water,

0.0384 g of ammonium peroxodisulfate,

are successively introduced into 1 l glass reactor surmounted by reflux condenser and equipped with a magnetic or mechanical stirrer and a temperature probe. The temperature is brought from 25° C. to 40° C. over 20 min and then to 45° C. over 10 min. It is subsequently maintained at 45° C. The acrylic acid (21.164 g, 0.294 mol) and ascorbic acid (0.0153 g) are separately introduced continuously over 5 h, while the temperature is maintained at 45° C. for a total of 14 h. The complex formed during the polymerization is subsequently separated from the aqueous phase and redissolved in a basic aqueous solution (pH: approximately 8; concentration by mass: approximately 15.5%).

Copolymer 4 (from the Macromonomer 2: 2 molar %):

The synthesis is carried out under nitrogen. The following:

19.67 g of macromonomer 2, i.e. 5.96×10⁻³ mol,

395 g of water,

0.12 g of ammonium peroxodisulfate, are successively introduced into a 1 l glass reactor surmounted by reflux condenser and equipped with a magnetic or mechanical stirrer and a temperature probe. The temperature is brought from 25° C. to 40° C. over 20 min and then to 45° C. over 10 min. It is subsequently maintained at 45° C. An acrylic acid solution (21 g, i.e. 0.292 mol, of acrylic acid in 5 g of water plus 4.2 g of a 5 mol/l sodium hydroxide solution) is introduced continuously over 5 h.

The introduction of a second solution (0.0493 g of ascorbic acid in 60 g of water) is begun at the same time; this solution is introduced continuously over 8 h.

The temperature is maintained at 45° C. for a total of 14 h.

The complex formed during the polymerization is subsequently separated from the aqueous phase and redissolved in water (pH approx. 7; concentration by mass: 6.13%).

### EXAMPLE 4

### Use of a Composition According to the Invention for Thickening a Coating Slip

In this example, coating slips are prepared according to the same formulation in which the nature of the thickener is changed from one test to another. The coating formulation used is a typical formulation for a chemical pulp paper upper coat comprising:

| | Parts |
|---|---|
| calcium carbonate | 75 |
| kaolin | 25 |
| latex binder | 11 |
| PVA (Rhodoviol 4/20) ® | 0.5 |
| 0.5 (polyvinyl alcohol sold | |
| by Rhône-Poulenc; mass- | |
| average molar mass: | |
| approximately 25 000; | |
| degree of hydrolysis: | |
| approximately 99%) | |
| thickener | variable |
| | (refer to the Tables) |

The various thicknesses tested are:

a carboxymethylcellulose (Finnfix FF30®, sold by Metsaserla), which is a binder currently employed by paper manufacturers for minimizing the phenomenon of mottling. This thickener is taken as control: control 1.

a methylcellulose (MC2000®, sold by Aqualon/Hercules): control 2. This modified cellulose, which is used in the composition of certain paints, has heat thickening properties. In contrast to the copolymers according to the invention, it displays strong whitening in solution on passing the LCST.

the copolymer 1, manufactured according to the synthetic process described in Example 1.

a first copolymer 2, referred to as copolymer 2a, manufactured according to the synthetic process described in Example 3.

a second copolymer 2, referred to as copolymer 2b, manufactured according to the synthetic process described in Example 3.

the copolymer 3 manufactured according to the synthetic process described in Example 3.

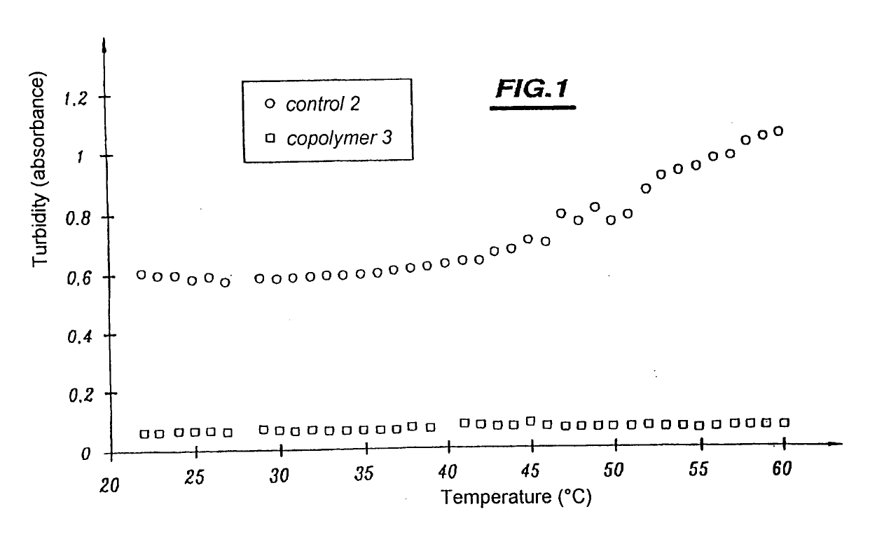

In solution, the copolymers of the invention exhibit a weak variation in turbidity as a function of the temperature, which distinguishes them from the other polymers having the heat thickening nature but displaying strong turbidity on passing the LCST. This property is illustrated in FIG. 1, where the change in the turbidity of the copolymer 3 and of the control 2 (methylcellulose) is plotted as a function of the temperature. The measurements are made with a turbidimeter (662 Photometer from Metrohm) in “absorbance” mode on 2% aqueous solutions, the temperature of which is regulated between 20 and 60° C. using a thermostatically-controlled bath.

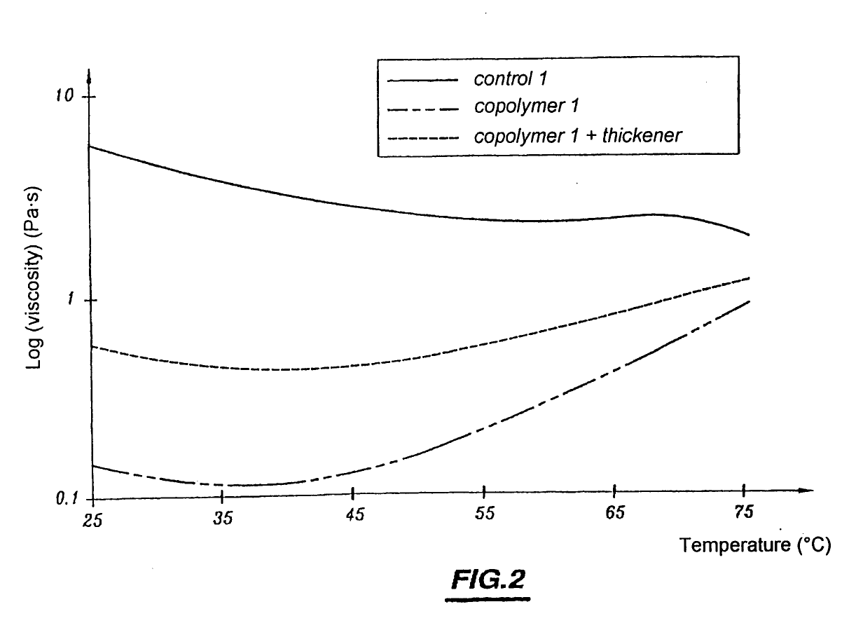

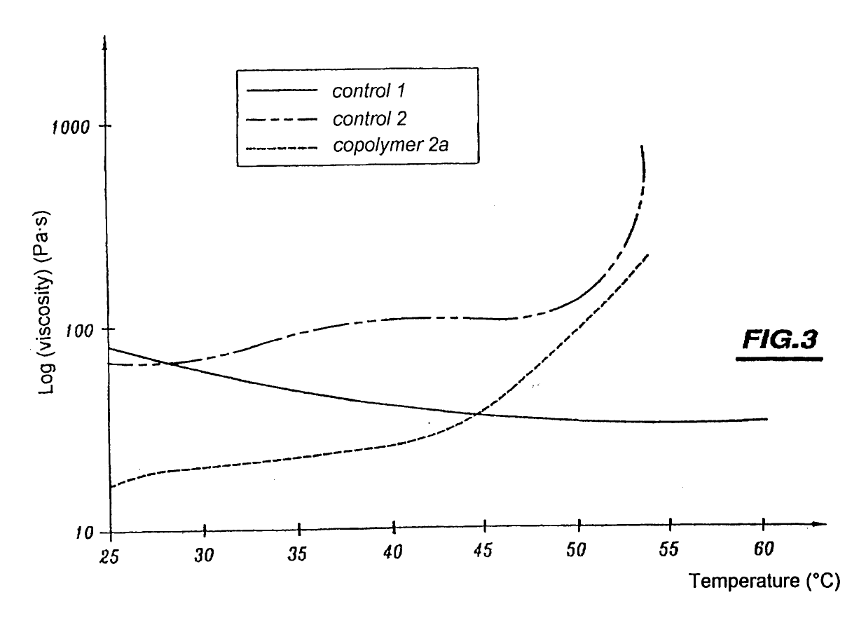

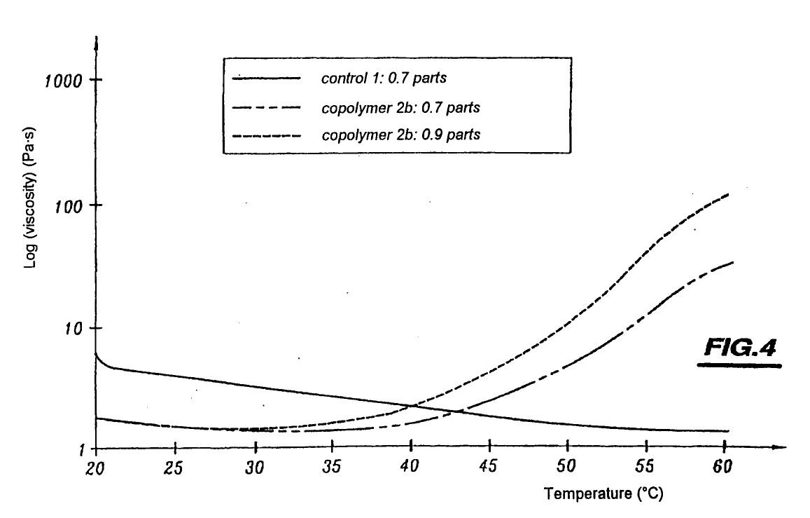

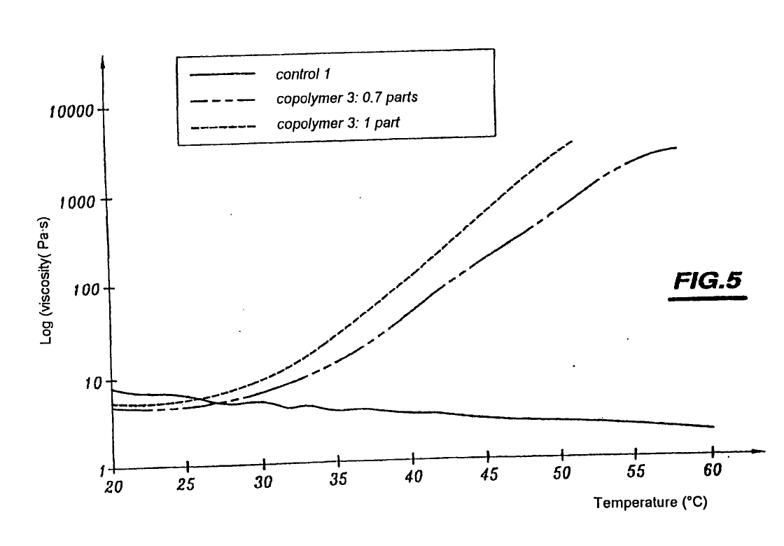

The viscosity of the slips is measured on a rheometer (Carri-med CSL100, manufactured by TA Instruments) in flow mode. The viscosity is recorded as a function of the temperature while keeping the controlled stress constant. The results are presented in FIGS. 2 to 5, where the measurements relating to the baths with the characteristics given in Tables 1 to 4 are plotted. For FIGS. 4 and 5, the controlled stress varies from one sample to another. It is adjusted for each them so that the flow at 20° C. takes place at a gradient of 10 s⁻¹, to allow a direct comparison of the viscosity of the coating surface at this temperature.

The heat thickening nature of the copolymers 1, 2 and 3 clearly emerges from FIGS. 2 to 5. This property is retained in the case of a mixture of the copolymer with carboxymethylcellulose. The control 2 is also heat thickening; only its variation in turbidity with the temperature distinguishes it, in terms of properties, from the copolymers according to the invention.

The coating slips are deposited on a precoated chemical pulp paper (Leykam PM9, 105 g/m²) with a Euclid Tool® brand laboratory blade coater.

The amount of slip deposited corresponds to a weight of coat shown in the tables.

In order for the coating tests to be more representative of the conditions which are found on an industrial scale and in order for the drying to be carried at high temperature in order to reveal the heat thickening properties of the copolymers according to the invention, instantaneous drying of the coat is carried out directly after the deposition. To this end, a thermal stripper is installed directly at the outlet of the blade coater, providing convective drying of the coat by a flow of air heated to approximately T=150° C.

The quality of the homogeneity of the coat coverage is assessed by a mottling test. The impressions are produced on a Prüfbau® laboratory press. The printing conditions are those recognized by persons skilled in the art for assessing the heterogeneity of the print rendering or mottling.

A strip of paper is printed with a metal roller covered with a film of ink. After a time of one second, during which the paper fixes a certain amount of ink, the unfixed ink is removed by producing a counter impression: the printed surface is wiped with a metal roller coated with rubber. This wiping operation is repeated 3 times, so as to thoroughly remove the unfixed ink. The impression and the counter impressions are produced at a speed of 0.5 m/s under a pressure of 800 kN/cm.

Ideally, the printing should result in a plain color distributed homogeneously over the paper. If this is not the case, there are heterogeneities in color, mottling, which is attributed to an unevenness in the structure of the coat (in the broad sense). The polymers according to the invention have an effect on the homogeneity of the coat. This is why their effect is thus assessed according to the criterion of mottling.

The evaluation is carried out according to the practices of the profession. It consists in judging the homogeneity of the print coloring determined by visual observation. A grade is attributed on a scale of 0 to 5, 0 being attributed to a completely homogeneous print and 5 to a print exhibiting very large fluctuations in color. A panel of 5 people carries out the grading; the values shown in Table 1 to 4 are the arithmetic mean of the results. In this context, the results should be compared within the same series (each series forms a object of a separate table) taking the value of the control slip (control 1) for reference.

The mottling grades, as a function of the nature of the thickener, are reported in Tables 1 to 4, which appear below.

TABLE 1

| | | | | | Copolymer 1 + | |
|---|---|---|---|---|---|---|
| Thickener | Control 1 | | Copolymer 1 | | thickener | |
| Nature | CMC | | PAA-g- | | PAA-g- | |
| | | | (POE/POP/POE) | | (POE/POP/ | |
| | | | | | POE) + CMC | |
| Molar fraction of | — | | 2.3% | | 2.3% + 0% | |
| the grafts | | | | | | |
| Amount of | 0.7 | parts | 2 | parts | 1 + 0.7 | |
| thickener | | | | | | |
| Solids content of | 64.8% | | 54.7% | | 57.3% | |
| the slip | | | | | | |
| Weight of the | 5.5 | g/m² | 4.5 | g/m² | 6.5 | g/m² |
| coat | | | | | | |
| Mottling grade | 2 | | 1 | | 0.2 | |
| (1s) | | | | | | |

TABLE 2

| Thickener | Control 1 | | Control 2 | | Copolymer 2a | |
|---|---|---|---|---|---|---|
| Nature | CMC | | MC | | PAA-g-(POE/ | |
| | | | | | POP/POE) | |
| Molar fraction of the | — | | — | | 1.8% | |
| grafts | | | | | | |
| Amount of thickener | 0.7 | parts | 0.4 | parts | 1 | part |
| Solids content of the | 63.3% | | 63.3% | | 63.3% | |
| slip | | | | | | |
| Weight of the coat | 7.0 | g/m² | 10 | g/m² | 8.5 | g/m² |
| Mottling grade (1s) | 2.6 | | 1.9 | | 0.8 | |

TABLE 3

| Thickener | Control 1 | | Copolymer 2b | | Copolymer 2b | |
|---|---|---|---|---|---|---|
| Nature | CMC | | PAA-g- | | PAA-g- | |
| | | | (POE/POP/POE) | | (POE/POP/POE) | |
| Molar fraction of | — | | 1.8% | | 1.8% | |
| the grafts | | | | | | |
| Amount of thickener | 0.7 | parts | 0.9 | parts | 0.7 | parts |
| Solids content of the | 64% | | 64% | | 64% | |
| slip | | | | | | |
| Weight of the coat | 6.5 | g/m² | 4.5 | g/m² | 5.0 | g/m² |
| Mottling grade (1s) | 4 | | 2.4 | | 2.6 | |

TABLE 4

| Thickener | Control 1 | | Copolymer 3 | | Copolymer 3 | |
|---|---|---|---|---|---|---|
| Nature | CMC | | PAA-g- | | PAA-g- | |
| | | | (POE/POP) | | (POE/POP) | |
| Molar fraction of the grafts | — | | 3% | | 3% | |
| Amount of thickener | 0.7 | parts | 0.7 | parts | 1 | part |
| Solids content of the slip | 66% | | 66% | | 66% | |
| Weight of the coat | 5.5 | g/m² | 7.4 | g/m² | 6.7 | g/m² |
| Mottling grade (1s) | 1.2 | | 0.4 | | 0.6 | |

The copolymers 1, 2 and 3, introduced into coating slips with the formula given above, result in coats applied in the manufacture of paper with printing properties which are better, with regard to the mottling criterion, than those obtained by using carboxymethylcellulose.

The copolymer 1 can be used in combination with carboxymethylcellulose and can result in an improvement in the printing properties with regard to the mottling criterion.

The copolymers 2 and 3 result in an improvement in the printing properties with regard to the mottling criterion for levels by mass of less than or equal to 1 part (value with respect to 100 parts of pigments).

The results obtained with the copolymers of the invention are better with respect to the mottling criterion than with methylcellulose, which has the property of increasing the viscosity with the temperature but not that of a constant turbidity with the temperature.

### EXAMPLE 5

### Use of a Composition According to the Invention for Improving the Spreading and Homogeneity Properties of a Coat to be Applied in the Manufacture of Paper

In this example, multicoated papers are manufactured which have the following structure. Two additional coats:

a starch-rich coat A, to which is added the copolymer 4 as heat thickening polymer according to the invention,

a coat B, the formula of which is representative of a chemical pulp paper upper coat, are deposited on a precoated Leykam PM9 substrate with a grammage of 105 g/m².

The results obtained are compared with those of a control in which the heat thickening polymer has not been introduced into the composition of the coat A.

The coats are deposited with a CLC6000 at the rate of 1200 m/min. The weight of each coat (A or B) is 11 g/m². The paper is heated prior to the deposition of the coating slip. The distance between the dryer and the coating head is 1 m.

The measurements made in characterizing the coated papers are measurements of gloss and of speed of ink taking, the latter quantity is obtained by an offsetting test: the greater the amount of ink transferred onto the set-off paper, the lower the ink taking. The homogeneity of the rate of ink taking is estimated by producing a solid with porometric ink.

The compositions of the coats tested and the results obtained are reported in Table 5 below:

TABLE 5

| | Control slip | Slip with |
|---|---|---|
| Test | without H.T. | H.T. |
| Composition of the coat (A) | | |
| Coarse carbonate (Carbital 60, Omya) | 100 | 100 |
| Rhodoviol 4/20 (Rhodia) | 0.5 | 0.5 |
| Fluorescent whitener (Blancophor, Bayer) | 0.5 | 0.5 |
| Starch (Perfectamyl 4692) | 9 | 9 |
| Rhodopas SB 083** | 4.5 | 4.5 |
| Copolymer 4 | 0 | 1 |
| Solids content (%) | 65 | 65 |
| pH | 8.5 | 8.5 |
| Coating conditions for the coat (A) | | |
| Coating machine | CLC6000 | CLC6000 |
| Coating rate (m/min) | 1200 | 1200 |
| Grammage (g/m²) | 11 | 11 |
| Composition of the coat (B) | | |
| Kaolin (ECC) | 50 | 50 |
| Fine carbonate (Carbital 90, Omya) | 50 | 50 |
| Rhodoviol 4/20 | 1 | 1 |
| Fluid CMC (CMC FF5 Finnfix) | 1 | 1 |
| Rhodopas SB 083 | 10 | 10 |
| Solids content (%) | 65 | 65 |
| pH | 8.5 | 8.5 |
| Coating conditions for the coat (B) | | |
| Coating machine | CLC6000* | CLC6000* |
| Coating rate (m/min) | 1200 | 1200 |
| Grammage (g/m²) | 11 | 11 |
| Characteristics of the papers | | |
| Surface condition | | |
| 75° virgin gloss (%) | 56 | 65 |
| Ink taking | | |
| Offsetting of Huber 520068 ink | | |
| 30 s | 0.72 | 0.47 |
| 60 s | 0.41 | 0.25 |
| 90 s | 0.26 | 0.15 |
| 120 s | 0.14 | 0.09 |
| Print homogeneity | | |
| Mottling, Lorilleux porometric ink | poor | excellent |

*CLC6000 is a high speed coating machine from “Sensor et Simulation”
**It is a carboxylated butadiene-styrene latex

It is found that the heat thickening polymer according to the invention, introduce into the coat (A), has a substantial influence on the properties of the upper coat:

the gloss thereof is higher

the ink taking is greater

the homogeneity of the coat is better.

The structure of the coat (A) can be controlled by the use of heat thickening polymers according to the invention. The effect has repercussions on the properties of the upper coat (B), according to a mechanism which involves the deposition conditions and the drying, with the consequence of an improvement in the spreading properties, a decrease in the migrations of the various constituents inside the coat, and a better homogeneity in the structure (these three properties being estimated respectively by measurements of gloss, of ink taking and of homogeneity of the impression).

### EXAMPLE 6

### Use of Heat Thickening Polymers According to the Invention in Limiting the Phenomenon of Migration which Occur During the Deposition and then the Drying of a Coat Applied in the Manufacture of Paper

In this example, multicoated papers are manufactured which have the following structure. Two additional coats:

a starch-rich coat A comprising the copolymer 4 as heat thickening polymer according to the invention,

a coat B, the formula of which is representative of a chemical pulp paper upper coat, are deposited on a precoated Leykam PM9 substrate with a grammage of 105 g/m². A coat formula comprising the heat thickener according to the invention is compared with a control formula without the heat thickener.

The starch present in the coat A mixes with the constituents of the upper coat B when the latter is deposited and then dried. In order to quantify the decrease in this phenomenon when a heat thickener is employed in the coat B, several coats A are manufactured with variable levels of starch. The amount of starch which migrates from the coat A to the coat B is revealed by applying a 5.5×10⁻³ mol/l iodine solution to the coated paper with a threaded rod (Threaded rod 1, which deposits a film of 6 microns). The iodine becomes colored on contact with the starch present at the surface of the paper. The intensity of this coloring is obtained by a measurement of reflectance at a wavelength of 540 nm). The lower the value obtained (the darker the color), the greater the amount of starch detected.

The coats are deposited with a threaded rod on a substrate heated to 150° C. and insulated with blotting paper. The coating of the coats A and B is carried out with a threaded rod and a grammage of 11 to 12 g/m² for the coat A and 10 g/m² for the coat B. The coating solids content is 52%.

The specific features used for each test are reported in Table 6 below and the results obtained are reported in Table 7.

TABLE 6

| | Slip with | Slip with | Slip with |
|---|---|---|---|
| Test | 3 P. starch | 6 P. starch | 9 P. starch |
| Composition of the coat (A) | | | |
| Coarse carbonate | 100 | 100 | 100 |
| (Carbital 60, Omya) | | | |
| Rhodoviol 4/20 (Rhodia) | 0.5 | 0.5 | 0.5 |
| Fluorescent whitener | 0.5 | 0.5 | 0.5 |
| (Blancophor, Bayer) | | | |
| Starch (Perfectamyl 4692) | 3 | 6 | 9 |
| Rhodopas SB 083 | 7.5 | 6 | 4.5 |
| Copolymer 4 | 1 | 1 | 1 |
| Solids content (%) | 52 | 52 | 52 |
| pH | 8.5 | 8.5 | 8.5 |
| (Viscosity at 60° C.)/ | X25 | X60 | X80 |
| (Viscosity at 25° C.) | | | |
| ratio | | | |

| | Control slip | Slip with |
|---|---|---|
| Composition of the coat (B) | without H.T. | H.T. |
| Kaolin (ECC) | 50 | 50 |
| Fine carbonate (Carbital 90, Omya) | 50 | 50 |
| Rhodoviol 4/20 | 1 | 1 |
| Fluid CMC (CMC FF5 Finnfix) | 1 | 1 |
| Rhodopas SB 083 | 10 | 10 |
| Copolymer 4 | 0 | 1 |
| Solids content (%) | 52 | 52 |
| pH | 8.5 | 8.5 |
| (Viscosity at 60° C.)/(Viscosity | X0.25* | X140 |
| at 25° C.) ratio | | |

*Typical value obtained under similar conditions on other slips than the “Control slip without H.T.” of the example

The visualization of the starch (with iodine) at the surface of the papers on which the two coats (A) and (B) have been deposited leads to the following results (expressed as units of reflectance at 540 nm)

TABLE 7

Composition of the coat (B)

| | | Without heat | With heat |
|---|---|---|---|
| | | thickener | thickener |
| Amount of | 3 p. | 64.5 | 75.1 |
| starch in | 6 p. | 50.9 | 62.5 |
| the coat (A) | 9 p. | 47.1 | 58.6 |

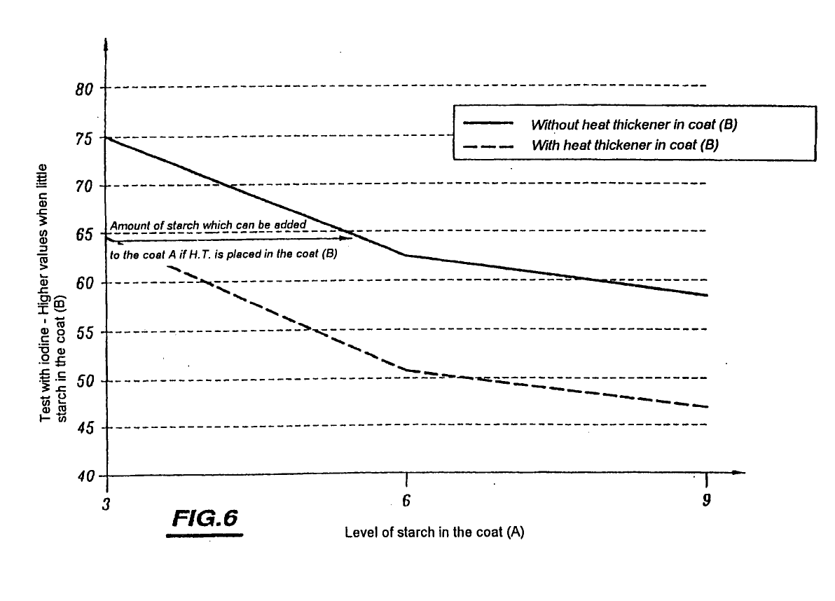

These results are also illustrated by FIG. 6.

The test carried out reveal substantially less starch in the upper coats of the paper when heat thickening polymer according to the invention is added to the coat (B). The amount of starch which can be added in the precoat can be estimated at 3 parts. By virtue of the use of a heat thickener according to the invention, the migrations which contribute to mixing the constituents of the coats (A) and (B) are limited and this excess of starch has no influence on the properties of the upper coat.

The use of heat thickener thus provides an economic advantage, as it is possible to decrease the cost of the coat (A) by placing therein more starch and less latex.

1. A heat thickening composition for coating slips comprising at least one heat-sensitive copolymer, characterized in that said copolymer has a comb structure and is composed of a polymer segment, known as the backbone segment, to which are grafted at least two identical or different polymer side segments with either the backbone segment or the side segments having a lower critical solubility temperature LCST of between 30 and 80° C.

2. A heat thickening composition as claimed in claim 1, characterized in that the polymer backbone has the lower critical solubility temperature LCST of between 30 and 80° C.

3. A heat thickening composition as claimed in claim 1, characterized in that the polymer side segments have the lower critical solubility temperature LCST of between 30 and 80° C.

4. A heat thickening composition as claimed in one of claims 1 to 3, characterized in that it comprises several copolymers arranged together so as to form a crosslinked structure in which their polymer segments having the lower critical solubility temperature LCST are the crosslinking nodes and at least a portion of their segments not having a lower critical solubility temperature between 30 and 80° C. establish connections between said nodes.

5. A heat thickening composition as claimed in one of claims 1, 2, 3 or 4, characterized in that the segments not having the lower critical solubility temperature of between 30° C. and 80° C. are water-soluble in at least this temperature range.

6. A heat thickening composition as claimed in one of the preceding claims, characterized in that the polymer segments not having a lower critical solubility temperature are water-soluble in the operating temperature range of said heat thickening composition.

7. A heat thickening composition as claimed in one of the preceding claims, characterized in that the polymer segment not having a critical temperature is a water-soluble polymer of ethylenic type.

8. A heat thickening composition as claimed in claim 7, characterized in that said polymer derives from the (co)polymerization of water-soluble ethylenic monomers of vinyl, acrylic, styrene or diene type and/or of vinyl ester type.

9. A heat thickening composition as claimed in claim 7 or 8, characterized in that the monomers are chosen from (meth)acrylic acid, diacids, such as fumaric acid or itaconic acid, or their salts, maleic anhydride, acrylamide and its derivatives, such as acrylamidomethylpropanesulfonic acid, or their salts, styrenesulfonic acid, vinylbenzoic acid or their salts, or vinylsulfonic acid, methallylsulfonic acid or their salts.

10. A heat thickening composition as claimed in claim 9, characterized in that the monomers are acrylic or methacrylic acid, acrylamides and their derivatives, fumaric and maleic acids and sulfonated monomers, such as 2-acrylamidomethylpropanesulfonic acid (AMPS) and its alkaline salts and vinylsulfonate.

11. A heat thickening composition as claimed in one of claims 7 to 10, characterized in that the polymer segments have a molecular weight at least of greater than 1 000 and preferably at least of greater than 20 000.

12. A heat thickening composition as claimed in one of claims 7 to 11, characterized in that the polymer segments result from the polymerization of acrylic acid (AA) and/or 2-acrylamidomethylpropanesulfonic acid (AMP).

13. A heat thickening composition as claimed in one of the preceding claims, characterized in that the polymer segments having a lower critical solubility temperature LCST of between 30 and 80° C. derive from polyoxyalkylene polymers.

14. A heat thickening composition as claimed in claim 13, characterized in that the oxyalkylene unit or the various oxyalkylene units present in the polyoxyalkylene have at most 6 carbon atoms.

15. A heat thickening composition as claimed in claim 13 or 14, characterized in that the polymer segments having a lower critical solubility temperature are composed of oxyethylene (OE) and/or oxypropylene (OP) units.

16. A heat thickening composition as claimed in one of claims 13 to 15, characterized in that the segments having a lower critical solubility temperature are composed of at least 5 oxyalkylene units.

17. A heat thickening composition as claimed in one of the preceding claims, characterized in that the copolymer comprises 0.1 molar % to 50 molar % of polymer segments having a lower critical solubility temperature (LCST) of between 30 and 80° C.

18. A heat thickening composition as claimed in one of the preceding claims, characterized in that the copolymer comprises 0.1 molar % to 5 molar % of polymer segments having a lower critical solubility temperature (LCST) of between 30 and 80° C.

19. A heat thickening composition as claimed in one of the preceding claims, characterized in that the copolymer is chosen from:
one copolymer prepared from POE-POP-POE triblock macromonomer and from acrylic acid (respective molar percentages: 2.3% and 97.7%),
one copolymer prepared from POE-POP-POE triblock macromonomer and from acrylic acid (respective molar %: 1.6% and 98.4%),
one copolymer prepared from POE-POP-POE triblock macromonomer and from acrylic acid (respective molar %: 3% and 97%), and
one copolymer prepared from POE-POP-POE triblock macromonomer and from acrylic acid (respective molar %: 2% and 98%), preferably by copolymerization.

20. A coating slip for the coating of paper and/or board comprising at least one heat thickening composition as claimed in one of claims 1 to 18.

21. The use of a heat thickening composition as claimed in one of claims 1 to 19 or of a coating slip as claimed in claim 20 in obtaining better coat coverage in the coating of paper and board.

22. The use of a heat thickening composition as claimed in one of claims 1 to 19 or of a coating slip according to claim 20 in improving the coat coverage in the coating of paper and board with a low weight of coat.

23. The use of a heat thickening composition as claimed in one of claims 1 to 19 or of a coating slip as claimed in claim 20 for improving the smoothness, the opaqueness and/or the gloss of coated paper and board with a low weight of coat.
